(19) United States
(12) Patent Application Publication
(10) Pub. No.: US 2025/0005592 A1
(43) Pub. Date: Jan. 2, 2025

(54) TECHNIQUES FOR STORING UNIQUE ITEM CHARACTERISTICS AS NON-FUNGIBLE TOKENS ON A BLOCKCHAIN

(71) Applicant: eBay Inc., San Jose, CA (US)

(72) Inventors: Tsun Kwan Donald Siu, Fremont, CA (US); Eswara Satya Pavan Rajesh Pinapala, Fremont, CA (US)

(21) Appl. No.: 18/215,792

(22) Filed: Jun. 28, 2023

(51) Int. Cl. G06Q 30/018; G06Q 20/38; G06Q 30/0601

(52) U.S. Cl. CPC G06Q 30/018; G06Q 20/3825; G06Q 20/389; G06Q 30/0623

(57) ABSTRACT

An online marketplace may authenticate an item, for example by identifying that the item has a unique characteristic. The online marketplace may generate a non-fungible token (NFT) on a blockchain that corresponds to an authenticated item for sale at the online marketplace. An NFT may indicate the unique characteristic of the item that was identified during the authentication process. A purchaser on the online marketplace may search for a given type of item. In response, the online marketplace searches the blockchain for NFTs that match the search and returns item listings based on the matched NFTs as well as authentication records for the item listings based on the NFTs. In some cases, a user may search for an item with a specific unique attribute, and the online marketplace may search for an NFT that indicates the corresponding item has that unique attribute.

### FIELD OF TECHNOLOGY

The present disclosure relates generally to database systems and data processing, and more specifically to techniques for storing unique item characteristics as non-fungible tokens (NFTs) on a blockchain in ecommerce.

### BACKGROUND

An online platform such as an online marketplace may provide listings of items for sale. Some items may be unique or non-fungible. Items may be non-fungible or unique, for example, based on unique characteristics such as a famous prior owner, or unique physical characteristics such as manufacturing qualities or defects. Item manufacturers may possess manufacturing records or authentication records that certify the uniqueness of an item, but such records may not be accessible to collectors or other downstream purchasers. Further, manufacturing and authentication records may be subject to fraud. Current systems for recording and storing the history of unique items may be fragmented and unreliable. Potential customers of an online marketplace may not be able to verify the history of a unique or non-fungible item listed for sale on the online marketplace.

### SUMMARY

A method is described. The method may include receiving, at an online marketplace from a user device, a search query for an item listing of the online marketplace, where the search query indicates a manufacturing attribute, searching a blockchain associated with the online marketplace for a set of non-fungible tokens (NFTs) that correspond to the manufacturing attribute, where the set of NFTs corresponds to a set of respective physical items authenticated by the online marketplace, where each of the set of NFTs is indicative of the manufacturing attribute, and where each of the set of NFTs is further indicative of a respective unique characteristic attribute, and returning, from the online marketplace to the user device, an indication of a set of item listings for the set of respective physical items, where the set of item listings indicates, for each of the set of respective physical items, the manufacturing attribute and the respective unique characteristic attribute.

An apparatus is described. The apparatus may include at least one processor, at least one memory coupled with the at least one processor, and instructions stored in the at least one memory. The instructions may be executable by the at least one processor to cause the apparatus to receive, at an online marketplace from a user device, a search query for an item listing of the online marketplace, where the search query indicates a manufacturing attribute, search a blockchain associated with the online marketplace for a set of NFTs that correspond to the manufacturing attribute, where the set of NFTs corresponds to a set of respective physical items authenticated by the online marketplace, where each of the set of NFTs is indicative of the manufacturing attribute, and where each of the set of NFTs is further indicative of a respective unique characteristic attribute, and return, from the online marketplace to the user device, an indication of a set of item listings for the set of respective physical items, where the set of item listings indicates, for each of the set of respective physical items, the manufacturing attribute and the respective unique characteristic attribute.

Another apparatus is described. The apparatus may include means for receiving, at an online marketplace from a user device, a search query for an item listing of the online marketplace, where the search query indicates a manufacturing attribute, means for searching a blockchain associated with the online marketplace for a set of NFTs that correspond to the manufacturing attribute, where the set of NFTs corresponds to a set of respective physical items authenticated by the online marketplace, where each of the set of NFTs is indicative of the manufacturing attribute, and where each of the set of NFTs is further indicative of a respective unique characteristic attribute, and means for returning, from the online marketplace to the user device, an indication of a set of item listings for the set of respective physical items, where the set of item listings indicates, for each of the set of respective physical items, the manufacturing attribute and the respective unique characteristic attribute.

A non-transitory computer-readable medium storing code is described. The code may include instructions executable by a processor to receive, at an online marketplace from a user device, a search query for an item listing of the online marketplace, where the search query indicates a manufacturing attribute, search a blockchain associated with the online marketplace for a set of NFTs that correspond to the manufacturing attribute, where the set of NFTs corresponds to a set of respective physical items authenticated by the online marketplace, where each of the set of NFTs is indicative of the manufacturing attribute, and where each of the set of NFTs is further indicative of a respective unique characteristic attribute, and return, from the online marketplace to the user device, an indication of a set of item listings for the set of respective physical items, where the set of item listings indicates, for each of the set of respective physical items, the manufacturing attribute and the respective unique characteristic attribute.

Some examples of the method, apparatuses, and non-transitory computer-readable medium described herein may further include operations, features, means, or instructions for receiving, with the search query, an indication of a unique characteristic attribute, where searching the blockchain further includes searching for a NFT that corresponds to the unique characteristic attribute, and where the set of item listings may be single item listing for a physical item that corresponds to the NFT.

Some examples of the method, apparatuses, and non-transitory computer-readable medium described herein may further include operations, features, means, or instructions for authenticating a physical item by identifying a unique characteristic attribute of the physical item and generating, based on the authenticating, a NFT on the blockchain, where the NFT may be indicative of the unique characteristic attribute.

Some examples of the method, apparatuses, and non-transitory computer-readable medium described herein may further include operations, features, means, or instructions for receiving, from the user device, a purchase request for a physical item of the set of respective physical items and updating, in response to a completion of a purchase of the physical item based on the purchase request, ownership of a NFT corresponding to the physical item on the blockchain.

Some examples of the method, apparatuses, and non-transitory computer-readable medium described herein may further include operations, features, means, or instructions for causing, at a user interface of the user device, display of the set of item listings.

In some examples of the method, apparatuses, and non-transitory computer-readable medium described herein, the respective unique characteristic attribute for each of the set of NFTs may be an ownership record for a corresponding respective physical item.

In some examples of the method, apparatuses, and non-transitory computer-readable medium described herein, the respective unique characteristic attribute for each of the set of NFTs may be a physical defect unique to a corresponding respective physical item.

In some examples of the method, apparatuses, and non-transitory computer-readable medium described herein, the manufacturing attribute may be a feature common to a set of multiple physical items.

### BRIEF DESCRIPTION OF THE DRAWINGS

FIG. 1 illustrates an example of an online marketplace system that supports techniques for storing unique item characteristics as non-fungible tokens (NFTs) on a blockchain in accordance with aspects of the present disclosure.

FIG. 2 shows an example of a flowchart that supports techniques for storing unique item characteristics as NFTs on a blockchain in accordance with aspects of the present disclosure.

FIG. 3 shows an example of a system that supports techniques for storing unique item characteristics as NFTs on a blockchain in accordance with aspects of the present disclosure.

FIG. 4 shows an example of a user interface view that supports techniques for storing unique item characteristics as NFTs on a blockchain in accordance with aspects of the present disclosure.

FIG. 5 shows an example of a process flow that supports techniques for storing unique item characteristics as NFTs on a blockchain in accordance with aspects of the present disclosure.

FIG. 6 shows a block diagram of an apparatus that supports techniques for storing unique item characteristics as NFTs on a blockchain in accordance with aspects of the present disclosure.

FIG. 7 shows a block diagram of an online marketplace manager that supports techniques for storing unique item characteristics as NFTs on a blockchain in accordance with aspects of the present disclosure.

FIG. 8 shows a diagram of a system including a device that supports techniques for storing unique item characteristics as NFTs on a blockchain in accordance with aspects of the present disclosure.

FIGS. 9 through 11 show flowcharts illustrating methods that support techniques for storing unique item characteristics as NFTs on a blockchain in accordance with aspects of the present disclosure.

### DETAILED DESCRIPTION

An online platform such as an online marketplace may provide listings of items for sale. Some items may be unique or non-fungible, for example, based on unique characteristics such as a famous prior owner, or unique physical characteristics such as manufacturing qualities or defects. Item manufacturers may possess manufacturing records or authentication records that certify the uniqueness of an item, but such records may not be accessible to collectors or other downstream purchasers. Further, manufacturing and authentication records may be subject to fraud. In some cases, records maintained by collectors may not provide a comprehensive record of the item, such as the production process or ownership history of the item. Accordingly, non-fungible items listed for sale on an online marketplace may lack a reliable ownership history or authentication records. Lack of comprehensive authentication and ownership records may increase the risk of fraud and misrepresentation, reduce purchasing transparency, and reduce the value of potentially unique items. For example, collectors may be unwilling to pay a premium for an item without a reliable record of the item's history.

An online marketplace may authenticate an item, for example by identifying that the item has a unique characteristic. The online marketplace may generate a non-fungible token (NFT) on a blockchain that corresponds to an authenticated item for sale at the online marketplace. An NFT is a mechanism that enables digital content to be treated as assets. An NFT does so by programmatically encoding a unique identity of an original digital asset which distinguishes it from copies of the asset. By using NFTs, a provenance of the digital asset is also tracked—a transfer of the digital asset cannot occur, due to programmatic features of NFTs, without the transfer being digitally recorded. An NFT may indicate the unique characteristic of the item that was identified during the authentication process. As an NFT on a blockchain cannot be changed, the authentication record of an item in NFT form is not subject to fraudulent changes. Further, the blockchain tracks every exchange involving each NFT, and accordingly, once created, the blockchain tracks the ownership history of the item corresponding to a given NFT. A purchaser on the online marketplace may search the online marketplace for a given type of item (e.g., a certain player's baseball card or a certain trading card). In response, the online marketplace may search the blockchain for NFTs that match the search and return item listings based on the matched NFTs as well as authentication records for the item listings based on the NFTs. For example, the authentication records may indicate unique characteristics such as prior owners or manufacturing defects. In some cases, a user may search for an item with a specific unique attribute (e.g., a trading card with a known manufacturing defect), and the online marketplace may search for an NFT that indicates the corresponding item has that unique attribute.

Aspects of the disclosure are initially described in the context of an system for cloud computing. Aspects of the disclosure are further illustrated by and described with reference to flowcharts, user interface views, process flows, apparatus diagrams, system diagrams, and flowcharts that relate to techniques for storing unique item characteristics as NFTs on a blockchain.

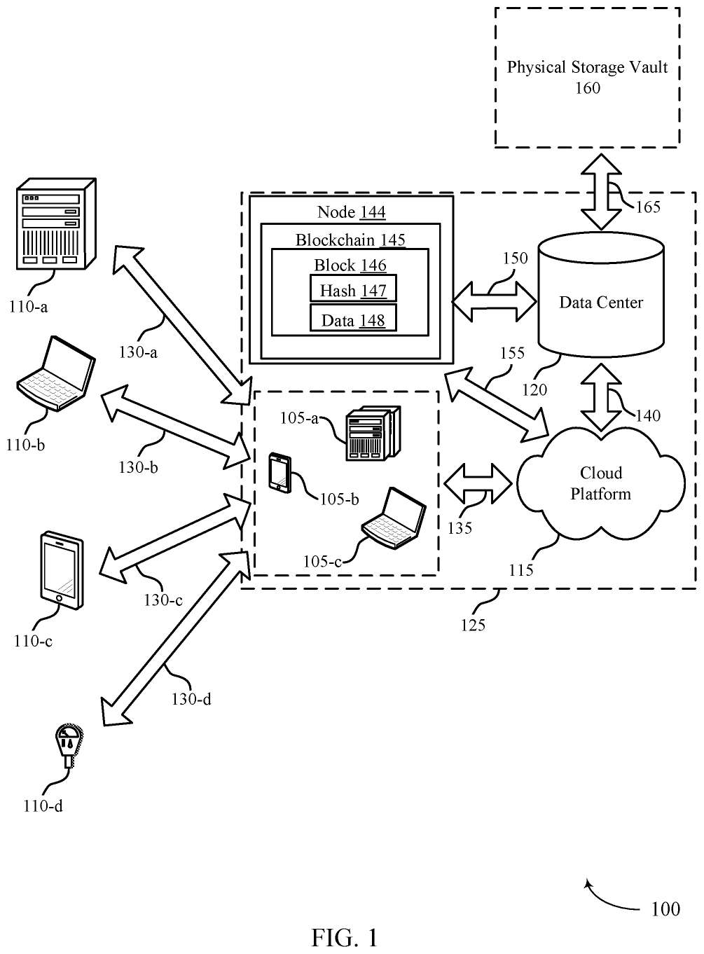

FIG. 1 illustrates an example of a system 100 for cloud computing that supports techniques for storing unique item characteristics as NFTs on a blockchain in accordance with various aspects of the present disclosure. The system 100 includes cloud clients 105, contacts (e.g., client devices 110), cloud platform 115, and data center 120. Cloud platform 115 may be an example of a public or private cloud network. A cloud client 105 may access cloud platform 115 over network connection 135. The network connection 135 may implement transfer control protocol and internet protocol (TCP/IP), such as the Internet, or may implement other network protocols. A cloud client 105 may be an example of a user/client device, such as a server (e.g., cloud client 105a), a smartphone (e.g., cloud client 105b), or a laptop (e.g., cloud client 105c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple client devices 110. The interactions 130 may include communications, opportunities, purchases, sales, or any other interaction between a cloud client 105 and a client device 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Client devices 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. In some cases, the client device 110 may be an example of a user device, such as a server (e.g., client device 110-a), a laptop (e.g., client device 110-b), a smartphone (e.g., client device 110-c), or a sensor (e.g., client device 110-d). In other cases, the client device 110 may be another computing system. In some cases, the client device 110 may be operated by a user or group of users. The user or group of users may be associated with a business, a manufacturer, or any other appropriate organization. In some cases, the interaction 130 may be a network connection 135 may implement transfer control protocol and internet protocol (TCP/IP), such as the Internet, or may implement other network protocols.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a client device 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a client device 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

Some ecommerce systems may provide an online marketplace. For example, the cloud platform 115 and/or the data center 120 may host an online marketplace. Some items listed on the online marketplace may be unique or non-fungible (e.g., based on unique characteristics such as a famous prior owner, or unique physical characteristics such as manufacturing qualities or defects). The online marketplace may authenticate a physical item, for example, by identifying that the physical item has a unique characteristic. An authenticated physical item may be stored in a physical storage vault 160 maintained by the online marketplace. The online marketplace may maintain a connection 165 to the physical storage vault 160 (e.g., records of the physical items in the physical storage vault 160 may be accessed and maintained at the data center 120 and/or the cloud platform 115), and the physical items in the physical storage vault 160 may be listed for sale on the online marketplace.

After authenticating a physical item, the online marketplace may generate (e.g., mint) an NFT that corresponds to an authenticated physical item for sale at the online marketplace that is stored in the physical storage vault 160. Records of the NFT may be stored on a blockchain 145, which may be accessible to the online marketplace (e.g., via a connection 150 with the data center or a connection 155 with the cloud platform).

The blockchain 145 may be implemented by one or more nodes 144 of the subsystem 125 (e.g., a node of a distributed network). For example, the node 144 may be connected to the data center 120 via a connection 150 and/or the node 144 may be connected to the cloud platform 115 via a connection 155. The node 144 may be a runtime implemented using processing, memory, and network resources of one or more computing devices that operate as the infrastructure of a blockchain 145. The blockchain 145 may include resource of one or more respective computing devices made available for operating as the node 144.

A copy of the blockchain 145 may be stored in storage of the one or more computing devices implementing the node 144. The blockchain 145 may be stored and maintained across multiple nodes 144 of the subsystem 125. The copy of the blockchain 145 stored at the storage of each node 144 may be a partial or full copy of the blockchain 145, depending on one or more characteristics of the particular node 144 (e.g., a type) and/or a time (e.g., whether updates have been made to the blockchain 145 via other nodes 144 in the subsystem 125). The nodes 144 store, communicate, process, and manage data that makes up the blockchain 145. The multiple nodes 144 may be interconnected to exchange data, e.g., as a peer-to-peer network in a distributed and decentralized manner.

The blockchain 145 may be formed using a plurality of blocks 146, illustrated in FIG. 1 as including a respective hash 147 and transaction data 148. The transaction data 148 of the blocks 146 includes batches of validated transactions that are hashed and encoded. Each of the blocks 146 includes the hash 147, which is a cryptographic hash of a previous block 146 in the blockchain 145, thereby linking the blocks 146 to each other to form the blockchain 145. As a result, the blocks 146 cannot be altered retroactively without altering each subsequent block 146 in the blockchain 145 and in this way protecting against attacks by malicious parties.

In order to publish the blocks 146 for addition to the blockchain 145, a node 144 may be implemented as a “miner” to add a block of transactions to the blockchain 146. In one or more implementations, other nodes may communicate transactions received at those nodes to one or more mining nodes for validation. Mining nodes may perform peer-to-peer computations to check if transactions intended for the blockchain 145 are valid and, if validated, may add validated transactions to a block 146 that those nodes are building. If the transactions are determined to be valid, for instance, then the transaction data 148 describing those transactions is encoded in or otherwise stored on a respective block 146, which is linked to the blockchain 145 such that the new block is “at the end” or “at the top” of the blockchain 145, e.g., through inclusion of the hash 147 of a previous block in the chain. Nodes broadcast such transaction history via the network for sharing with other nodes, which acts to synchronize the blocks 146 of the blockchain 145 across the distributed architecture of computing devices. Due in part to the distributed storage and updating of the blockchain 145 over a network nodes 144, the blockchain 145 may store data in a decentralized manner, without a centralized database (e.g., run by a clearinghouse), and thus operate as a distributed ledger. As a distributed ledger, the blockchain 145 supports the secure transfer of digital assets, such as the transfer of a cryptocurrency and/or tokens (e.g., NFTs). Tokens may be created “on top” of the blockchain 145 by using a “token standard” which allows the token to interoperate with the network of nodes 144 according to one or more protocols of the blockchain, such that the transaction data 148 and the hashes 147 of the blocks 146 are leveraged to create, trade, and update tokens.

In accordance with the described techniques, for instance, the architecture and protocols of the blockchain 145 can be leveraged to create non-fungible tokens (NFTs) on the blockchain 145. By using the transaction validation carried out by the nodes 144, the blockchain 145 certifies that a given NFT is digitally unique and thus not interchangeable with other NFTs. When an NET is minted (i.e., programmatically brought into existence), the protocols of the blockchain 145 generate a unique token identifier that is encoded in the NFT—the unique identifier may be generated using one or more randomization approaches. As used herein, the term “non-fungible” refers to the property of a token to uniquely represent an asset, such that a digital signature of the token represents the underlying asset in a way that is not directly interchangeable with (e.g., “like-for-like”), or equal to, any other tokens. Each NFT is programmatically created to include a unique, non-transferable identity which distinguishes it from other NFTs. As discussed herein, an NFT created and maintained on the blockchain 145 may be configured to encode identifying information.

By using NFTs, a provenance of the digital asset is also tracked—a transfer of the digital asset cannot occur, due to programmatic features of NFTs, without the transfer being digitally recorded. An NFT may indicate the unique characteristic of the item that was identified during the authentication process. As an NFT on the blockchain 145 cannot be changed, the authentication record of an item in NFT form is not subject to fraudulent changes. Further, the blockchain 145 tracks every exchange involving each NFT, and accordingly, once created, the blockchain 145 tracks the ownership history of the physical item corresponding to a given NFT.

A purchaser (e.g., at a client device 110) on the online marketplace may search the online marketplace for a given type of item (e.g., a certain player's baseball card or a certain trading card). In response, the online marketplace may search the blockchain 145 for NFTs that match the search and return item listings based on the matched NFTs as well as authentication records for the item listings based on the NFTs. For example, the authentication records may indicate unique characteristics such as prior owners or manufacturing defects. In some cases, a user may search for an item with a specific unique attribute (e.g., a trading card with a known manufacturing defect or that was previously owned by a celebrity), and the online marketplace may search for an NFT that indicates the corresponding item has that unique attribute.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

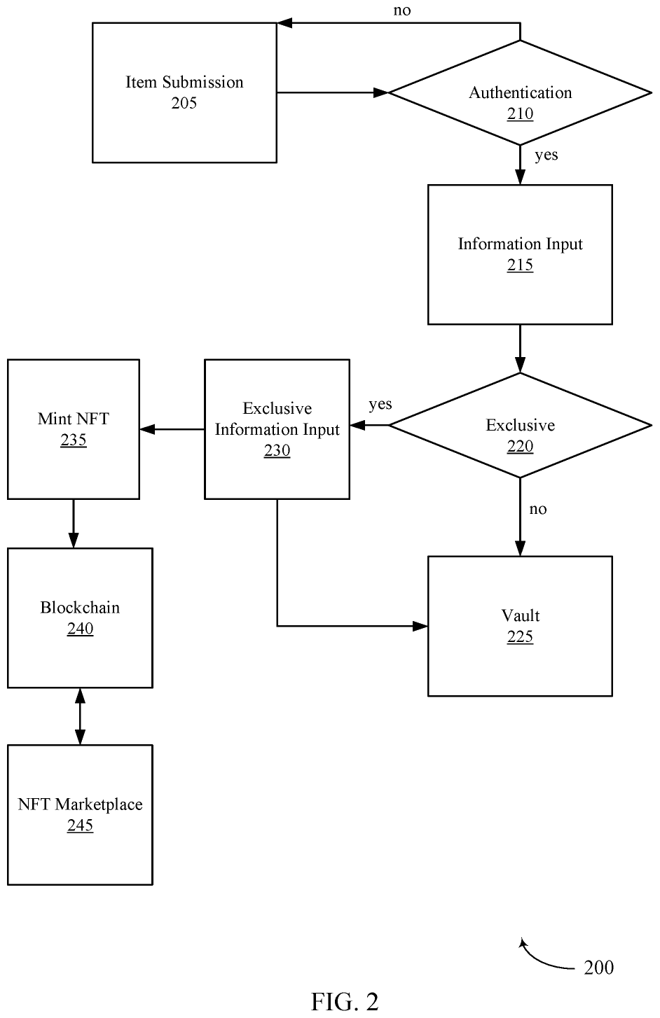

FIG. 2 shows an example of a flowchart 200 that supports techniques for storing unique item characteristics as NFTs on a blockchain in accordance with aspects of the present disclosure. Aspects of the flowchart 200 may implement, or be implemented by, aspects of the system 100.

At 205, an item owner may submit a physical item to an online marketplace for authentication. At 210, the online marketplace may authenticate the item authentic (e.g., to detect one or more manufacturing attributes of the item). For example, an authentication process may involve manual physical inspection of the item to determine whether the item is an authentic item or counterfeit/forgery. The authentication process at 210 may categorize the item. For example, the authentication process at 210 may identify that the item is a certain type of trading card or a card of a given baseball player made by a given baseball card manufacturer for a given year. In some examples, the authentication process may involve machine authentication, such as machine analysis of photographs or videos of the item to detect whether the item is authentic. If the item is determined at 210 not to be authentic, the online marketplace may return the item to the item owner.

If the item is determined at 210 to be authentic, at 215, the online marketplace may generate a listing for the item and may input information for the item to the listing. For example, the listing may include collectible type information such as one or more manufacturing attributes identified during the authentication process and/or a photograph or image of the item.

At 220, the authentication process may identify whether the item is unique or non-fungible (e.g., exclusive). In some examples, identifying whether the item is unique or non-fungible may involve manual or machine inspection of the item to detect unique manufacturing qualities or defects. In some examples, identifying whether the item is unique or non-fungible may involve signature validation for autographed items. In some examples, a previous owner may make an item unique (e.g., an item owned by a famous individual), and accordingly authentication of prior ownership records may be used to identify whether an item is unique or non-fungible. If the item is determined to not be unique or non-fungible, at 225 the item may be stored in a physical storage vault 160, and an item listing may be created for the item on the online marketplace that indicates the item is fungible or is not unique.

At 230, if the item is determined at 220 to be unique or non-fungible, the authenticator (e.g., the online marketplace) may input information to the listing regarding the unique characteristics of the item and/or the authentication process. For example, a video may be recorded for the item, explaining the authentication process for the item, or both. The unique or non-fungible item may then be stored in the physical storage vault 160 at 225, and an item listing may be created for the item on the online marketplace that indicates the item is non-fungible or unique. In some examples, the information input to the listing regarding the unique characteristics of the item and/or the authentication process may include artifact metadata (e.g., product grade, product defects, etc.), a scanned 3D model of the physical item, a time at which the product was authenticated, a video of the product, a name of one or more current or prior owners of the product, or the like, or any combination thereof.

At 235, the online marketplace may mint a NFT corresponding to the unique or non-fungible item stored in the physical storage vault 160, and the NFT may be maintained on the blockchain at 240. The NFT may identify the authenticator (e.g., the online marketplace) and may identify manufacturing characteristics and unique characteristics of the item identified at 210, 220, and 230. The NFT may also indicate the owner of the NFT, which corresponds to the owner of the item stored in the physical vault such as physical storage vault 160.

At 245, a potential purchaser may search the blockchain using an NFT marketplace. For example, the potential purchaser may search for items having certain manufacturing characteristics and/or unique characteristics, and the NFT marketplace may search for NFTs corresponding to physical items having the indicated manufacturing characteristics and/or unique characteristics. The NFT marketplace may link the returned NFTs to item listings at the online marketplace. As described herein, if a customer purchases the physical item, the ownership of the corresponding NFT is accordingly updated to reflect the purchase of the physical item.

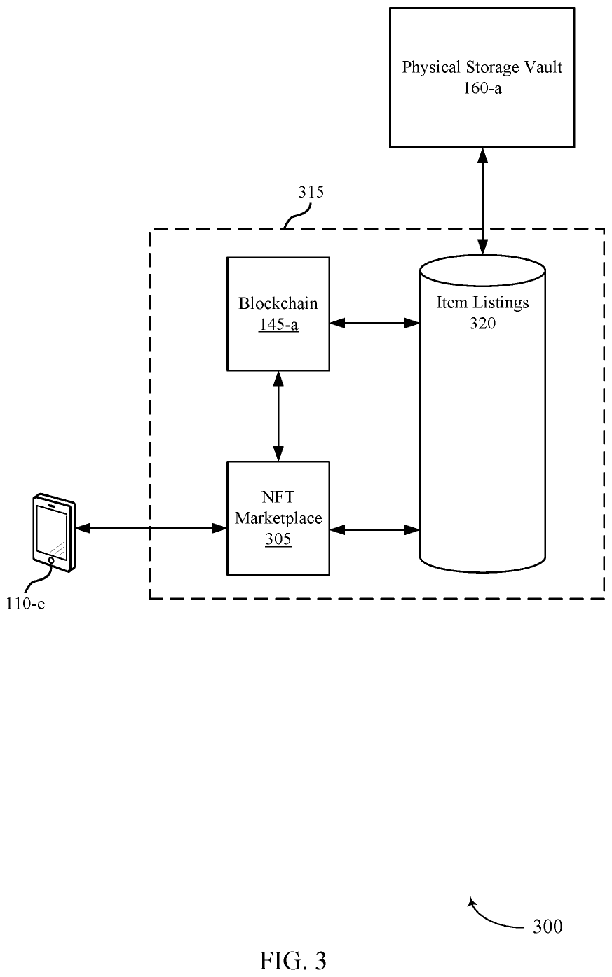

FIG. 3 shows an example of a system 300 that supports techniques for storing unique item characteristics as NFTs on a blockchain in accordance with aspects of the present disclosure. Aspects of the system 300 may implement, or be implemented by, aspects of the system 100. For example, the system 300 may include a physical storage vault 160-a, which may be an example of a physical storage vault 160 as described herein. The system 300 may include a blockchain 145-a, which may be an example of a blockchain 145 as described herein. The system may include a client device 110-e, which may be an example of a client device 110 as described herein.

As described herein, authenticated physical items may be stored in a physical storage vault 160-a. Item listings 320 for the physical items may be hosted on an online marketplace 315. The online marketplace 315 (e.g., the operator of the online marketplace 315) may manage the physical storage vault 160-a and may authenticate the physical items stored in the physical storage vault 160-a. As described herein, upon authentication of a physical item, the online marketplace 315 may mint an NFT corresponding to the physical item on the blockchain 145-a, where the NFT includes information that indicates one or more authenticated manufacturing characteristics and unique characteristics for the physical item.

A customer, for example a user of the client device 110-e, may access an NFT marketplace 305 associated with the online marketplace 315 which lists NFTs for sale. In some aspects, a same operator may manage both the online marketplace 315 and the NFT marketplace 305. In some examples, the online marketplace 315 may include the NFT marketplace 305. At the NFT marketplace 305, the customer may search for manufacturing and/or unique attributes or characteristics. An example customer query, for example, may be “Charizard Card.” The NFT marketplace 305 may search the blockchain for NFTs that include a “Charizard Card” manufacturing characteristic. Accordingly, the NFT marketplace 305 may return a set of NFTs and links to corresponding item listings 320 for Charizard cards. The item listings 320 presented to the customer on the client device 110-e may indicate unique characteristics for the Charizard cards based on the unique characteristic indicated in the NFTs. For example, a unique characteristic for a Charizard card may be a color defect, color combination, a misspelling, misprint (e.g., misalignment), image alignment or misalignment, a particular serial number, or any combination thereof. In some aspects, the customer may search for a unique characteristic. For example, a customer may search for a Charizard card with a particular manufacturing defect, misspelling, misprint, or serial number.

If the customer purchases a particular physical item presented in an item listing 320, ownership of the physical item in the physical storage vault 160-a is transferred to the customer and ownership of the corresponding NFT is also transferred to that customer on the blockchain 145. Accordingly, NFTs may be used to track the ownership of a physical item. In some cases, ownership by a particular person (e.g., a celebrity) may make an item unique or non-fungible. In such cases, a customer may search for physical items that are or were owned by a particular person/entity (e.g., a unique characteristic may be past or current ownership as recorded by the NFT).

In some examples, if an item is removed from the physical storage vault 160-a, the corresponding NFT may be destroyed, as the online marketplace 315 no longer has physical control of the item (e.g., can no longer ensure that the item is authentic).

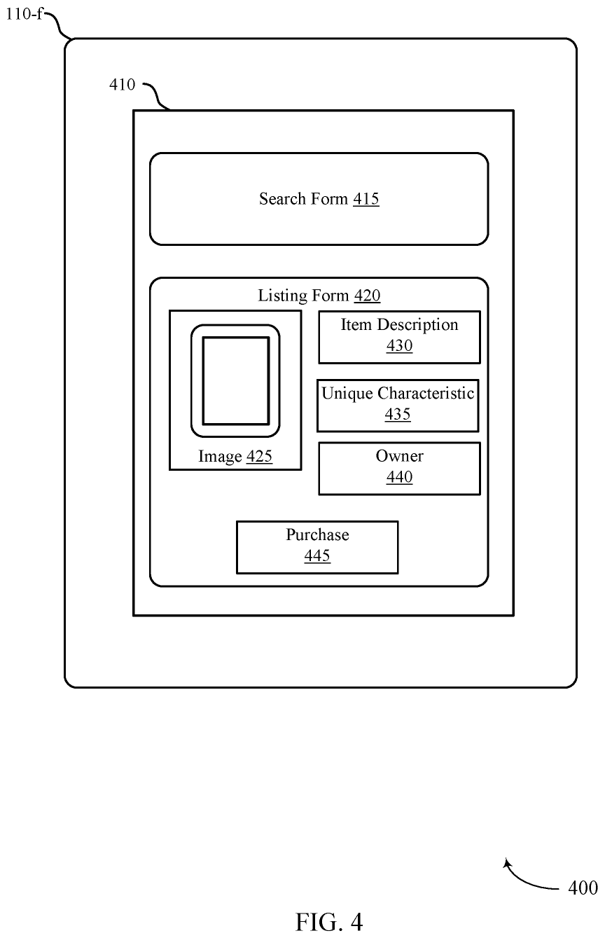

FIG. 4 shows an example of a user interface view 400 that supports techniques for storing unique item characteristics as NFTs on a blockchain in accordance with aspects of the present disclosure. Aspects of the user interface view 400 may implement, or be implemented by, aspects of the system 100. For example, the user interface view 400 may be presented on a display 410 of a client device 110-f, which may be an example of a client device 110 as described herein.

A customer of an online marketplace may search for NFTs that correspond to physical items listed for sale on the online marketplace. For example, the customer may input desired manufacturing characteristic(s), desired unique characteristic(s) for a physical item, or both, into the search form 415 of the user interface view 400. The customer may input text, make a selection from a drop down menu, or the like. The online marketplace may return one or more item listings in an listing form 420 of the user interface view 400 based on the customer search. For example, the online marketplace may search a blockchain for NFTs that include manufacturing characteristics, unique characteristics, or both, that at least partially matches the customer input in the search form 415.

The listing form 420 may include, for a given NFT/item listing an image 425 of the physical item corresponding to the returned NFT, a field 430 for an item description (e.g., one or more manufacturing characteristics indicated by the NFT), a field 435 for a unique characteristic of the item indicated by the NFT. In some cases, the listing form 420 may indicate a field 440 indicating the current owner of the NFT and the corresponding physical item. The listing form 420 may include an interactable field 445 that provides an option to purchase the NFT and the corresponding physical item. If the customer purchases the physical item, ownership of the NFT is similarly passed to and recorded on the blockchain as passing to the customer. In some cases, the purchased item may remain in a physical storage vault 160. In other cases, the purchased item may be picked up by or physically delivered to the purchaser.

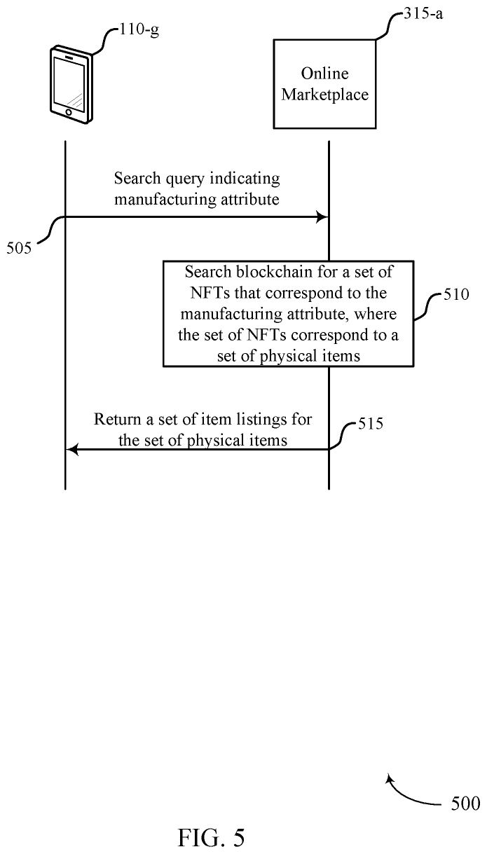

FIG. 5 shows an example of a process flow 500 that supports techniques for storing unique item characteristics as NFTs on a blockchain in accordance with aspects of the present disclosure. The process flow 500 may implement or be implemented by a system 100 of FIG. 1 or a system 300 of FIG. 3. For example, the process flow includes a client device 110-g, which may be an example of a client device 110 as described herein, and an online marketplace 315-a, which may be an example of an online marketplace 315 as described herein. In the following description of the process flow 500, the operations between the client device 110-g and the online marketplace 315-a may be transmitted in a different order than the example order shown, or the operations performed by the client device 110-g and the online marketplace 315-a may be performed in different orders or at different times. Some operations may also be omitted from the process flow 500, and other operations may be added to the process flow 500.

At 505, the online marketplace 315-a may receive, from the client device 110-g, a search query for an item listing of the online marketplace. The search query may indicate a manufacturing attribute. In some aspects, the manufacturing attribute may be a feature common to a plurality of physical items (e.g., a particular type of trading card). Examples of manufacturing attributes include a year of manufacture, a manufacturer, a product category, country of origin, a product size, product dimensions, model number, a brand, or the like, or any combination thereof. A manufacturing attribute may refer to a set of one or more attributes that are common to a particular product or item.

At 510, the online marketplace 315-a may search a blockchain associated with the online marketplace for a set of NFTs that correspond to the manufacturing attribute. The set of NFTs correspond to a set of respective physical items authenticated by the online marketplace, and each of the set of NFTs is indicative of the manufacturing attribute. Each of the set of NFTs is further indicative of a unique characteristic attribute for the physical item that corresponds to the NFT. Unique characteristic attributes may be one or more features of a product that are distinctive or exclusive to a particular item or product. Examples of unique characteristic attribute include a manufacturing defect, a scratch, a particular product owner, a color defect or scheme, or the like, or any combination thereof. In some aspects, the unique characteristic attribute for each of the set of NFTs may be an ownership record for a corresponding respective physical item. In some aspects, the unique characteristic attribute for each of the set of NFTs may be a physical defect unique to a corresponding respective physical item (e.g., where the manufacturing attribute is a particular type of trading card, the unique characteristic attribute may be a misprint, misspelling, or unique color).

At 515, the online marketplace 315-a may send, to the client device 110-g, an indication of a set of item listings for the set of respective physical items. The set of item listings may indicate, for each of the set of respective physical items, the manufacturing attribute and the respective unique characteristic attribute. The set of item listings may be displayed at a user interface of the client device 110-g.

In some examples, the search query may further indicate of a unique characteristic attribute, and the online marketplace 315-a may search the blockchain for NFTs that correspond to the unique characteristic attribute. In such examples, the set of item listings may be a single item listing for a physical item that has the indicated unique characteristic attribute.

In some examples, the online marketplace 315-a may authenticate a physical item by identifying a unique characteristic of the physical item. The online marketplace 315-a may generate an NFT corresponding to the authenticated physical item, and the NFT indicates the unique characteristic attribute.

In some examples, the online marketplace 315-a may receive, from the client device 110-g, a purchase request for a physical item of the set of respective physical items. The online marketplace 315-a may update, in response to a completion of a purchase of the physical item based on the purchase request, ownership of a NFT corresponding to the physical item on the blockchain.

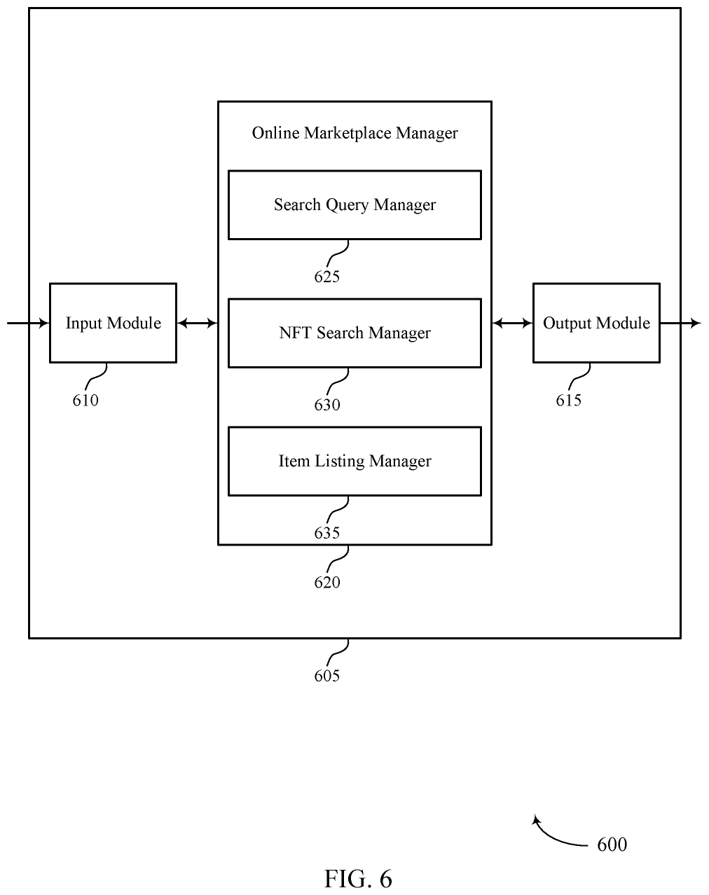

FIG. 6 shows a block diagram 600 of a device 605 that supports techniques for storing unique item characteristics as NFTs on a blockchain in accordance with aspects of the present disclosure. The device 605 may include an input module 610, an output module 615, and an online marketplace manager 620. The device 605, or one of more components of the device 605 (e.g., the input module 610, the output module 615, and the online marketplace manager 620 that implements online marketplace 315), may include at least one processor, which may be coupled with at least one memory, to support the described techniques. Each of these components may be in communication with one another (e.g., via one or more buses).

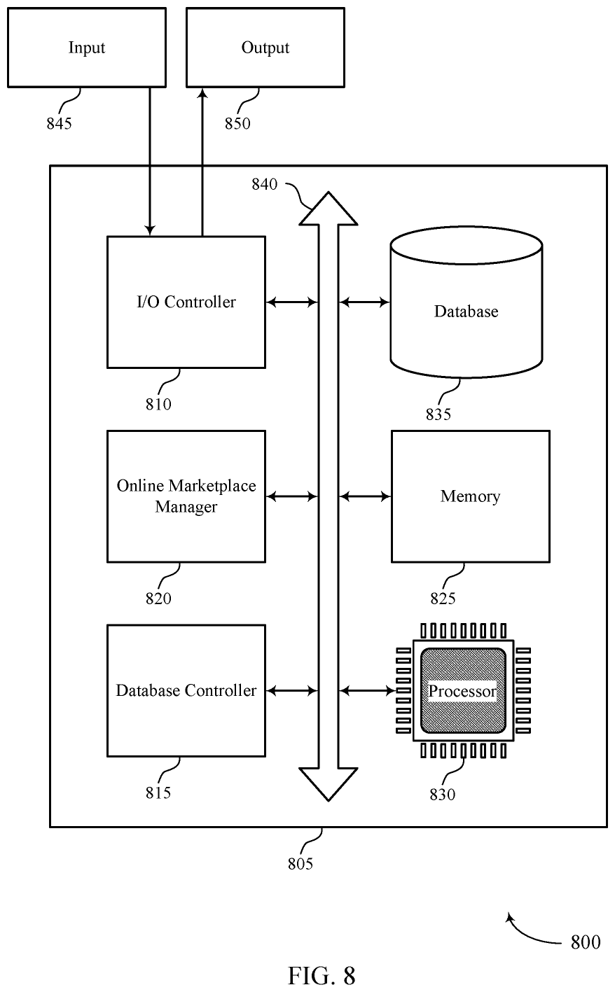

The input module 610 may manage input signals for the device 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the device 605 for processing. For example, the input module 610 may transmit input signals to the online marketplace manager 620 to support techniques for storing unique item characteristics as NFTs on a blockchain. In some cases, the input module 610 may be a component of an I/O controller 810 as described with reference to FIG. 8.

The output module 615 may manage output signals for the device 605. For example, the output module 615 may receive signals from other components of the device 605, such as the online marketplace manager 620, and may transmit these signals to other components or devices. In some examples, the output module 615 may transmit output signals for display in a user interface, for storage in a database or data store, for further processing at a server or server cluster, or for any other processes at any number of devices or systems. In some cases, the output module 615 may be a component of an I/O controller 810 as described with reference to FIG. 8.

For example, the online marketplace manager 620 may include a search query manager 625, an NFT search manager 630, an item listing manager 635, or any combination thereof. In some examples, the online marketplace manager 620, or various components thereof, may be configured to perform various operations (e.g., receiving, monitoring, transmitting) using or otherwise in cooperation with the input module 610, the output module 615, or both. For example, the online marketplace manager 620 may receive information from the input module 610, send information to the output module 615, or be integrated in combination with the input module 610, the output module 615, or both to receive information, transmit information, or perform various other operations as described herein.

The search query manager 625 may be configured as or otherwise support a means for receiving, at an online marketplace from a user device, a search query for an item listing of the online marketplace, where the search query indicates a manufacturing attribute. The NFT search manager 630 may be configured as or otherwise support a means for searching a blockchain associated with the online marketplace for a set of NFTs that correspond to the manufacturing attribute, where the set of NFTs corresponds to a set of respective physical items authenticated by the online marketplace, where each of the set of NFTs is indicative of the manufacturing attribute, and where each of the set of NFTs is further indicative of a respective unique characteristic attribute. The item listing manager 635 may be configured as or otherwise support a means for returning, from the online marketplace to the user device, an indication of a set of item listings for the set of respective physical items, where the set of item listings indicates, for each of the set of respective physical items, the manufacturing attribute and the respective unique characteristic attribute.

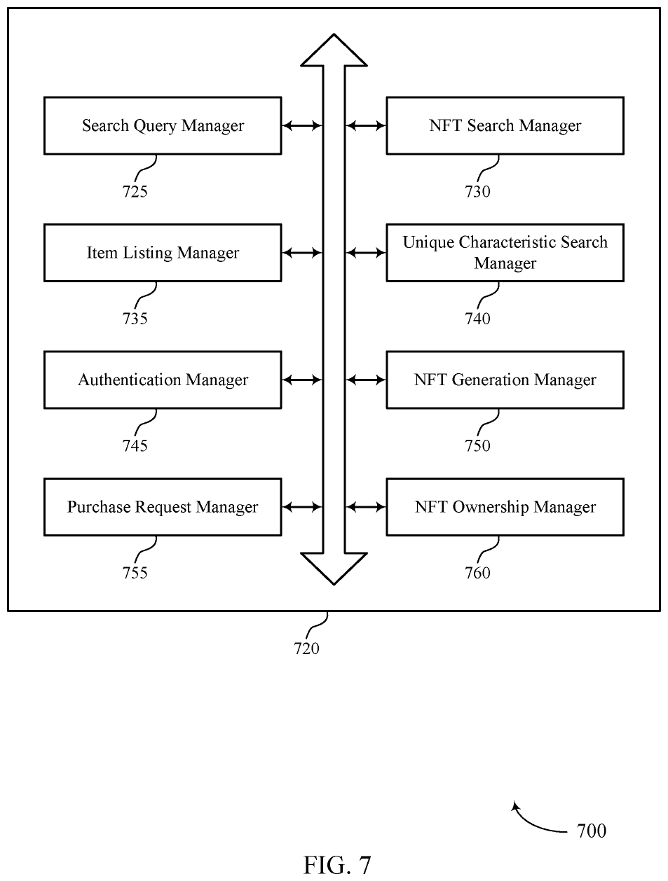

FIG. 7 shows a block diagram 700 of an online marketplace manager 720 that supports techniques for storing unique item characteristics as NFTs on a blockchain in accordance with aspects of the present disclosure. The online marketplace manager 720 may be an example of aspects of an online marketplace manager or an online marketplace manager 620, or both, as described herein. The online marketplace manager 720, or various components thereof, may be an example of means for performing various aspects of techniques for storing unique item characteristics as NFTs on a blockchain as described herein. For example, the online marketplace manager 720 may include a search query manager 725, an NFT search manager 730, an item listing manager 735, a unique characteristic search manager 740, an authentication manager 745, an NFT generation manager 750, a purchase request manager 755, an NFT ownership manager 760, or any combination thereof. Each of these components, or components of subcomponents thereof (e.g., one or more processors, one or more memories), may communicate, directly or indirectly, with one another (e.g., via one or more buses).

The search query manager 725 may be configured as or otherwise support a means for receiving, at an online marketplace from a user device, a search query for an item listing of the online marketplace, where the search query indicates a manufacturing attribute. The NFT search manager 730 may be configured as or otherwise support a means for searching a blockchain associated with the online marketplace for a set of NFTs that correspond to the manufacturing attribute, where the set of NFTs corresponds to a set of respective physical items authenticated by the online marketplace, where each of the set of NFTs is indicative of the manufacturing attribute, and where each of the set of NFTs is further indicative of a respective unique characteristic attribute. The item listing manager 735 may be configured as or otherwise support a means for returning, from the online marketplace to the user device, an indication of a set of item listings for the set of respective physical items, where the set of item listings indicates, for each of the set of respective physical items, the manufacturing attribute and the respective unique characteristic attribute.

In some examples, the unique characteristic search manager 740 may be configured as or otherwise support a means for receiving, with the search query, an indication of a unique characteristic attribute, where searching the blockchain further includes searching for a NFT that corresponds to the unique characteristic attribute, and where the set of item listings is single item listing for a physical item that corresponds to the NFT.

In some examples, the authentication manager 745 may be configured as or otherwise support a means for authenticating a physical item by identifying a unique characteristic attribute of the physical item. In some examples, the NFT generation manager 750 may be configured as or otherwise support a means for generating, based on the authenticating, a NFT on the blockchain, where the NFT is indicative of the unique characteristic attribute.

In some examples, the purchase request manager 755 may be configured as or otherwise support a means for receiving, from the user device, a purchase request for a physical item of the set of respective physical items. In some examples, the NFT ownership manager 760 may be configured as or otherwise support a means for updating, in response to a completion of a purchase of the physical item based on the purchase request, ownership of a NFT corresponding to the physical item on the blockchain.

In some examples, the item listing manager 735 may be configured as or otherwise support a means for causing, at a user interface of the user device, display of the set of item listings.

In some examples, the respective unique characteristic attribute for each of the set of NFTs is an ownership record for a corresponding respective physical item.

In some examples, the respective unique characteristic attribute for each of the set of NFTs is a physical defect unique to a corresponding respective physical item.

In some examples, the manufacturing attribute is a feature common to a set of multiple physical items.

FIG. 8 shows a diagram of a system 800 including a device 805 that implements the online marketplace 315 and supports techniques for storing unique item characteristics as NFTs on a blockchain in accordance with aspects of the present disclosure. The device 805 may be an example of or include the components of a device 605 as described herein. The device 805 may include components for bi-directional data communications including components for transmitting and receiving communications, such as an online marketplace manager 820, an I/O controller 810, a database controller 815, at least one memory 825, at least one processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and ROM. The memory 825 may store computer-readable, computer-executable software including instructions that, when executed, cause the processor 830 to perform various functions described herein. In some cases, the memory 825 may contain, among other things, a BIOS which may control basic hardware or software operation such as the interaction with peripheral components or devices.

The processor 830 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in a memory 825 to perform various functions (e.g., functions or tasks supporting techniques for storing unique item characteristics as NFTs on a blockchain).

For example, the online marketplace manager 820 may be configured as or otherwise support a means for receiving, at an online marketplace from a user device, a search query for an item listing of the online marketplace, where the search query indicates a manufacturing attribute. The online marketplace manager 820 may be configured as or otherwise support a means for searching a blockchain associated with the online marketplace for a set of NFTs that correspond to the manufacturing attribute, where the set of NFTs corresponds to a set of respective physical items authenticated by the online marketplace, where each of the set of NFTs is indicative of the manufacturing attribute, and where each of the set of NFTs is further indicative of a respective unique characteristic attribute. The online marketplace manager 820 may be configured as or otherwise support a means for returning, from the online marketplace to the user device, an indication of a set of item listings for the set of respective physical items, where the set of item listings indicates, for each of the set of respective physical items, the manufacturing attribute and the respective unique characteristic attribute.

By including or configuring the online marketplace manager 820 in accordance with examples as described herein, the device 805 may support techniques for improved authentication reliability and security. For example, as an NFT on a blockchain cannot be changed, the authentication record of an item in NFT form is not subject to fraudulent changes. As described herein, identifying characteristics of a physical item may be encoded into a corresponding NFT, and thus authentication information for a physical item may be secured in an NFT recorded on a blockchain. Further, the blockchain tracks every exchange involving each NFT, and accordingly, once created, the blockchain tracks the ownership history of the item corresponding to a given NFT. Thus, generation of NFTs that correspond to authenticated physical items may support improved authentication reliability and security for physical items available for purchase on an online marketplace.

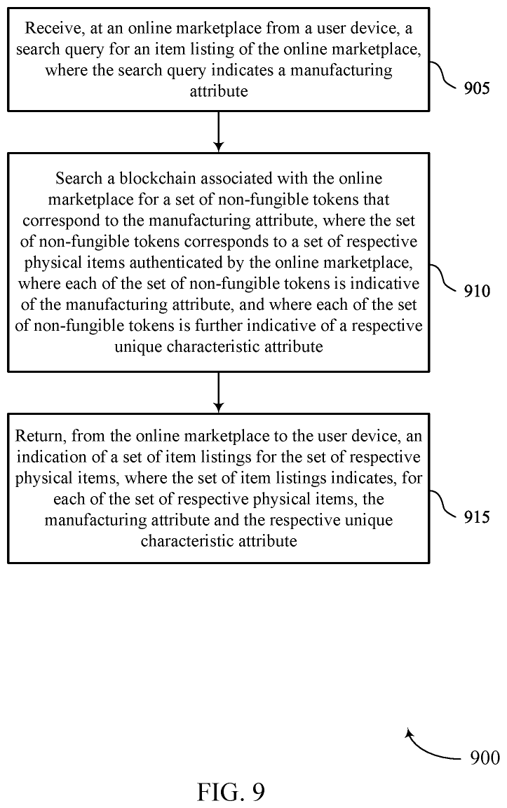

FIG. 9 shows a flowchart illustrating a method 900 that supports techniques for storing unique item characteristics as NFTs on a blockchain in accordance with aspects of the present disclosure. The operations of the method 900 may be implemented by an online marketplace manager or its components as described herein. For example, the operations of the method 900 may be performed by an online marketplace manager as described with reference to FIGS. 1 through 8. In some examples, an online marketplace manager may execute a set of instructions to control the functional elements of the online marketplace manager to perform the described functions. Additionally, or alternatively, the online marketplace manager may perform aspects of the described functions using special-purpose hardware.

At 905, the method may include receiving, at an online marketplace from a user device, a search query for an item listing of the online marketplace, where the search query indicates a manufacturing attribute. The operations of block 905 may be performed in accordance with examples as disclosed herein. In some examples, aspects of the operations of 905 may be performed by a search query manager 725 as described with reference to FIG. 7.

At 910, the method may include searching a blockchain associated with the online marketplace for a set of NFTs that correspond to the manufacturing attribute, where the set of NFTs corresponds to a set of respective physical items authenticated by the online marketplace, where each of the set of NFTs is indicative of the manufacturing attribute, and where each of the set of NFTs is further indicative of a respective unique characteristic attribute. The operations of block 910 may be performed in accordance with examples as disclosed herein. In some examples, aspects of the operations of 910 may be performed by an NFT search manager 730 as described with reference to FIG. 7.

At 915, the method may include returning, from the online marketplace to the user device, an indication of a set of item listings for the set of respective physical items, where the set of item listings indicates, for each of the set of respective physical items, the manufacturing attribute and the respective unique characteristic attribute. The operations of block 915 may be performed in accordance with examples as disclosed herein. In some examples, aspects of the operations of 915 may be performed by an item listing manager 735 as described with reference to FIG. 7.

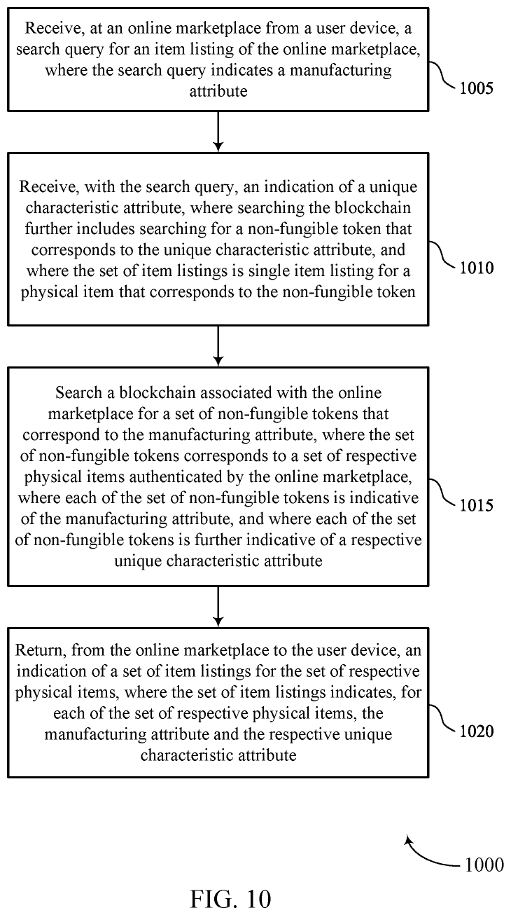

FIG. 10 shows a flowchart illustrating a method 1000 that supports techniques for storing unique item characteristics as NFTs on a blockchain in accordance with aspects of the present disclosure. The operations of the method 1000 may be implemented by an online marketplace manager or its components as described herein. For example, the operations of the method 1000 may be performed by an online marketplace manager as described with reference to FIGS. 1 through 8. In some examples, an online marketplace manager may execute a set of instructions to control the functional elements of the online marketplace manager to perform the described functions. Additionally, or alternatively, the online marketplace manager may perform aspects of the described functions using special-purpose hardware.

At 1005, the method may include receiving, at an online marketplace from a user device, a search query for an item listing of the online marketplace, where the search query indicates a manufacturing attribute. The operations of block 1005 may be performed in accordance with examples as disclosed herein. In some examples, aspects of the operations of 1005 may be performed by a search query manager 725 as described with reference to FIG. 7.

At 1010, the method may include receiving, with the search query, an indication of a unique characteristic attribute, where searching the blockchain further includes searching for a NFT that corresponds to the unique characteristic attribute, and where the set of item listings is single item listing for a physical item that corresponds to the NFT. The operations of block 1010 may be performed in accordance with examples as disclosed herein. In some examples, aspects of the operations of 1010 may be performed by a unique characteristic search manager 740 as described with reference to FIG. 7.

At 1015, the method may include searching a blockchain associated with the online marketplace for a set of NFTs that correspond to the manufacturing attribute, where the set of NFTs corresponds to a set of respective physical items authenticated by the online marketplace, where each of the set of NFTs is indicative of the manufacturing attribute, and where each of the set of NFTs is further indicative of a respective unique characteristic attribute. The operations of block 1015 may be performed in accordance with examples as disclosed herein. In some examples, aspects of the operations of 1015 may be performed by an NFT search manager 730 as described with reference to FIG. 7.

At 1020, the method may include returning, from the online marketplace to the user device, an indication of a set of item listings for the set of respective physical items, where the set of item listings indicates, for each of the set of respective physical items, the manufacturing attribute and the respective unique characteristic attribute. The operations of block 1020 may be performed in accordance with examples as disclosed herein. In some examples, aspects of the operations of 1020 may be performed by an item listing manager 735 as described with reference to FIG. 7.

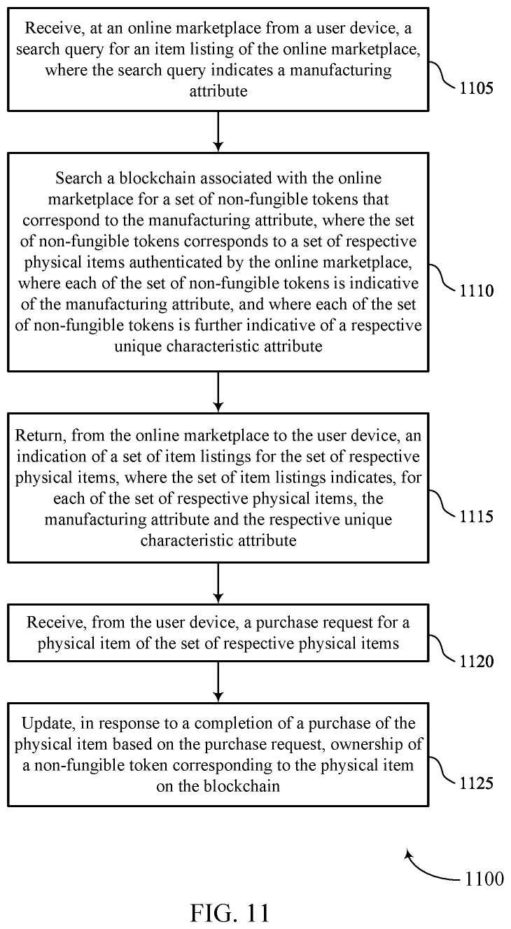

FIG. 11 shows a flowchart illustrating a method 1100 that supports techniques for storing unique item characteristics as NFTs on a blockchain in accordance with aspects of the present disclosure. The operations of the method 1100 may be implemented by an online marketplace manager or its components as described herein. For example, the operations of the method 1100 may be performed by an online marketplace manager as described with reference to FIGS. 1 through 8. In some examples, an online marketplace manager may execute a set of instructions to control the functional elements of the online marketplace manager to perform the described functions. Additionally, or alternatively, the online marketplace manager may perform aspects of the described functions using special-purpose hardware.

At 1105, the method may include receiving, at an online marketplace from a user device, a search query for an item listing of the online marketplace, where the search query indicates a manufacturing attribute. The operations of block 1105 may be performed in accordance with examples as disclosed herein. In some examples, aspects of the operations of 1105 may be performed by a search query manager 725 as described with reference to FIG. 7.

At 1110, the method may include searching a blockchain associated with the online marketplace for a set of NFTs that correspond to the manufacturing attribute, where the set of NFTs corresponds to a set of respective physical items authenticated by the online marketplace, where each of the set of NFTs is indicative of the manufacturing attribute, and where each of the set of NFTs is further indicative of a respective unique characteristic attribute. The operations of block 1110 may be performed in accordance with examples as disclosed herein. In some examples, aspects of the operations of 1110 may be performed by an NFT search manager 730 as described with reference to FIG. 7.

At 1115, the method may include returning, from the online marketplace to the user device, an indication of a set of item listings for the set of respective physical items, where the set of item listings indicates, for each of the set of respective physical items, the manufacturing attribute and the respective unique characteristic attribute. The operations of block 1115 may be performed in accordance with examples as disclosed herein. In some examples, aspects of the operations of 1115 may be performed by an item listing manager 735 as described with reference to FIG. 7.

At 1120, the method may include receiving, from the user device, a purchase request for a physical item of the set of respective physical items. The operations of block 1120 may be performed in accordance with examples as disclosed herein. In some examples, aspects of the operations of 1120 may be performed by a purchase request manager 755 as described with reference to FIG. 7.

At 1125, the method may include updating, in response to a completion of a purchase of the physical item based on the purchase request, ownership of a NFT corresponding to the physical item on the blockchain. The operations of block 1125 may be performed in accordance with examples as disclosed herein. In some examples, aspects of the operations of 1125 may be performed by an NFT ownership manager 760 as described with reference to FIG. 7.

The following provides an overview of aspects of the present disclosure:

Aspect 1: A computer-implemented method comprising: receiving, at an online marketplace from a user device, a search query for an item listing of the online marketplace, wherein the search query indicates a manufacturing attribute; searching a blockchain associated with the online marketplace for a set of NFTs that correspond to the manufacturing attribute, wherein the set of NFTs corresponds to a set of respective physical items authenticated by the online marketplace, wherein each of the set of NFTs is indicative of the manufacturing attribute, and wherein each of the set of NFTs is further indicative of a respective unique characteristic attribute; and returning, from the online marketplace to the user device, an indication of a set of item listings for the set of respective physical items, wherein the set of item listings indicates, for each of the set of respective physical items, the manufacturing attribute and the respective unique characteristic attribute.

Aspect 2: The computer-implemented method of aspect 1, further comprising: receiving, with the search query, an indication of a unique characteristic attribute, wherein searching the blockchain further comprises searching for a NFT that corresponds to the unique characteristic attribute, and wherein the set of item listings is single item listing for a physical item that corresponds to the NFT.

Aspect 3: The computer-implemented method of any of aspects 1 through 2, further comprising: authenticating a physical item by identifying a unique characteristic attribute of the physical item; and generating, based on the authenticating, a NFT on the blockchain, wherein the NFT is indicative of the unique characteristic attribute.

Aspect 4: The computer-implemented method of any of aspects 1 through 3, further comprising: receiving, from the user device, a purchase request for a physical item of the set of respective physical items; and updating, in response to a completion of a purchase of the physical item based on the purchase request, ownership of a NFT corresponding to the physical item on the blockchain.

Aspect 5: The computer-implemented method of any of aspects 1 through 4, further comprising: causing, at a user interface of the user device, display of the set of item listings.

Aspect 6: The computer-implemented method of any of aspects 1 through 5, wherein the respective unique characteristic attribute for each of the set of NFTs is an ownership record for a corresponding respective physical item.

Aspect 7: The computer-implemented method of any of aspects 1 through 6, wherein the respective unique characteristic attribute for each of the set of NFTs is a physical defect unique to a corresponding respective physical item.

Aspect 8: The computer-implemented method of any of aspects 1 through 7, wherein the manufacturing attribute is a feature common to a plurality of physical items.

Aspect 9: An apparatus comprising at least one processor; at least one memory coupled with the at least one processor; and instructions stored in the at least one memory and executable by the at least one processor to cause the apparatus to perform a method of any of aspects 1 through 8.

Aspect 10: An apparatus comprising at least one means for performing a method of any of aspects 1 through 8.

Aspect 11: A non-transitory computer-readable medium storing code the code comprising instructions executable by a processor to perform a method of any of aspects 1 through 8.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A computer-implemented method comprising:
receiving, at an online marketplace from a user device, a search query for an item listing of the online marketplace, wherein the search query indicates a manufacturing attribute;
searching a blockchain associated with the online marketplace for a set of non-fungible tokens that correspond to the manufacturing attribute, wherein the set of non-fungible tokens corresponds to a set of respective physical items authenticated by the online marketplace, wherein each of the set of non-fungible tokens is indicative of the manufacturing attribute, and wherein each of the set of non-fungible tokens is further indicative of a respective unique characteristic attribute; and
returning, from the online marketplace to the user device, an indication of a set of item listings for the set of respective physical items, wherein the set of item listings indicates, for each of the set of respective physical items, the manufacturing attribute and the respective unique characteristic attribute.

2. The computer-implemented method of claim 1, further comprising:
receiving, with the search query, an indication of a unique characteristic attribute, wherein searching the blockchain further comprises searching for a non-fungible token that corresponds to the unique characteristic attribute, and wherein the set of item listings is single item listing for a physical item that corresponds to the non-fungible token.

3. The computer-implemented method of claim 1, further comprising:
authenticating a physical item by identifying a unique characteristic attribute of the physical item; and
generating, based on the authenticating, a non-fungible token on the blockchain, wherein the non-fungible token is indicative of the unique characteristic attribute.

4. The computer-implemented method of claim 1, further comprising:
receiving, from the user device, a purchase request for a physical item of the set of respective physical items; and
updating, in response to a completion of a purchase of the physical item based on the purchase request, ownership of a non-fungible token corresponding to the physical item on the blockchain.

5. The computer-implemented method of claim 1, further comprising:
causing, at a user interface of the user device, display of the set of item listings.

6. The computer-implemented method of claim 1, wherein the respective unique characteristic attribute for each of the set of non-fungible tokens is an ownership record for a corresponding respective physical item.

7. The computer-implemented method of claim 1, wherein the respective unique characteristic attribute for each of the set of non-fungible tokens is a physical defect unique to a corresponding respective physical item.

8. The computer-implemented method of claim 1, wherein the manufacturing attribute is a feature common to a plurality of physical items.

9. An apparatus, comprising:
at least one processor;
at least one memory coupled with the at least one processor; and
instructions stored in the at least one memory and executable by the at least one processor to cause the apparatus to:
receive, at an online marketplace from a user device, a search query for an item listing of the online marketplace, wherein the search query indicates a manufacturing attribute;
search a blockchain associated with the online marketplace for a set of non-fungible tokens that correspond to the manufacturing attribute, wherein the set of non-fungible tokens corresponds to a set of respective physical items authenticated by the online marketplace, wherein each of the set of non-fungible tokens is indicative of the manufacturing attribute, and wherein each of the set of non-fungible tokens is further indicative of a respective unique characteristic attribute; and
return, from the online marketplace to the user device, an indication of a set of item listings for the set of respective physical items, wherein the set of item listings indicates, for each of the set of respective physical items, the manufacturing attribute and the respective unique characteristic attribute.

10. The apparatus of claim 9, wherein the instructions are further executable by the at least one processor to cause the apparatus to:
receive, with the search query, an indication of a unique characteristic attribute, wherein searching the blockchain further comprises searching for a non-fungible token that corresponds to the unique characteristic attribute, and wherein the set of item listings is single item listing for a physical item that corresponds to the non-fungible token.

11. The apparatus of claim 9, wherein the instructions are further executable by the at least one processor to cause the apparatus to:
authenticate a physical item by identifying a unique characteristic attribute of the physical item; and
generate, based on the authenticating, a non-fungible token on the blockchain, wherein the non-fungible token is indicative of the unique characteristic attribute.

12. The apparatus of claim 9, wherein the instructions are further executable by the at least one processor to cause the apparatus to:
receive, from the user device, a purchase request for a physical item of the set of respective physical items; and
update, in response to a completion of a purchase of the physical item based on the purchase request, ownership of a non-fungible token corresponding to the physical item on the blockchain.

13. The apparatus of claim 9, wherein the instructions are further executable by the at least one processor to cause the apparatus to:
cause, at a user interface, display of the set of item listings.

14. The apparatus of claim 9, wherein the respective unique characteristic attribute for each of the set of non-fungible tokens is an ownership record for a corresponding respective physical item.

15. The apparatus of claim 9, wherein the respective unique characteristic attribute for each of the set of non-fungible tokens is a physical defect unique to a corresponding respective physical item.

16. The apparatus of claim 9, wherein the manufacturing attribute is a feature common to a plurality of physical items.

17. A non-transitory computer-readable medium storing code, the code comprising instructions executable by at least one processor to:
receive, at an online marketplace from a user device, a search query for an item listing of the online marketplace, wherein the search query indicates a manufacturing attribute;
search a blockchain associated with the online marketplace for a set of non-fungible tokens that correspond to the manufacturing attribute, wherein the set of non-fungible tokens corresponds to a set of respective physical items authenticated by the online marketplace, wherein each of the set of non-fungible tokens is indicative of the manufacturing attribute, and wherein each of the set of non-fungible tokens is further indicative of a respective unique characteristic attribute; and
return, from the online marketplace to the user device, an indication of a set of item listings for the set of respective physical items, wherein the set of item listings indicates, for each of the set of respective physical items, the manufacturing attribute and the respective unique characteristic attribute.

18. The non-transitory computer-readable medium of claim 17, wherein the instructions are further executable by the at least one processor to:
receive, with the search query, an indication of a unique characteristic attribute, wherein searching the blockchain further comprises searching for a non-fungible token that corresponds to the unique characteristic attribute, and wherein the set of item listings is single item listing for a physical item that corresponds to the non-fungible token.

19. The non-transitory computer-readable medium of claim 17, wherein the instructions are further executable by the at least one processor to:
authenticate a physical item by identifying a unique characteristic attribute of the physical item; and
generate, based on the authenticating, a non-fungible token on the blockchain, wherein the non-fungible token is indicative of the unique characteristic attribute.

20. The non-transitory computer-readable medium of claim 17, wherein the instructions are further executable by the at least one processor to:
receive, from the user device, a purchase request for a physical item of the set of respective physical items; and
update, in response to a completion of a purchase of the physical item based on the purchase request, ownership of a non-fungible token corresponding to the physical item on the blockchain.
